(19) United States
(12) Patent Application Publication
(10) Pub. No.: US 2022/0110380 A1
(43) Pub. Date: Apr. 14, 2022

(54) FACE MASK WITH ADJUSTABLE NOSE FIT

(71) Applicant: Mats Moosberg, Torslanda (SE)

(72) Inventor: Mats Moosberg, Torslanda (SE)

(21) Appl. No.: 17/496,991

(22) Filed: Oct. 8, 2021

Related U.S. Application Data
(60) Provisional application No. 63/090,230, filed on Oct. 11, 2020.

(51) Int. Cl. A41D 13/11

(52) U.S. Cl. CPC A41D 13/1107; A41D 13/1161

(57) ABSTRACT

The present invention relates to a facemask comprising an adjustable nose fit for perfectly closing the nose gap and method thereof. The facemask comprising a sheet, a plurality of curved creases on the sheet at the nose area (upper side). The facemask also comprises a string or ribbon or thread). The string or thread or ribbon is capable of adjusting the contact contour at the nose area and making the facemask perfectly fit to the wearer. The present invention provides a facemask comprising an arrangement to perfectly fit the facemask to the wearer. The present invention provides a facemask perfectly fit to the persons, irrespective of their age, face shape or size of the face. The production of facemasks with an adjustable nose fit can be made by simply cutting a sheet of material into shape at high production volume. The facemask may also comprise an air flow filter module. In an alternate embodiment, the facemask hook-pins or snap-it arrangement is used instead of the string. Further, in an alternate embodiment, the facemask of the present invention may also include second transparent sheet which acts as a protection visor towards the wearers' eyes when attached to the face.

### CROSS REFERENCE TO RELATED APPLICATIONS

This application is a non-provisional application and claims the benefit under 35 U.S.C. 119 (e) of U.S. provisional application No. 63/090230 filed on Oct. 11, 2020 and hereby incorporated by reference in their entireties into this application.

### FEDERALLY SPONSORED RESEARCH AND DEVELOPMENT

Not applicable.

### MICROFICHE

Not applicable

### FIELD OF THE INVENTION

The present invention generally relates to the field of protective facemasks, The invention, particularly relates to a facemask comprising an adjustable nose fit for perfectly closing the nose gap and method thereof.

### BACKGROUND OF THE INVENTION

A respirator is a device designed to protect the wearer from inhaling hazardous or irritating atmospheres, including fumes, vapours, extreme temperatures, gases and particulate matter such as dusts and airborne microorganisms. There are two main categories: the air-purifying respirator, in which reparable air is obtained by filtering a contaminated atmosphere, and the air-supplied respirator, in which an alternate supply of breathable air is delivered. Within each category, different techniques are employed to reduce or eliminate noxious airborne contaminants. Air-purifying respirators range from relatively inexpensive single-use, disposable face masks sometimes referred to as a dust mask to more robust reusable models with replaceable cartridges often called a gas mask.

Many different types and styles of face-masks have been advanced, and each in its own fashion is suitable for a particular purpose. The faces of people vary greatly with respect facial features regarding size, arrangement, facial contours, etc. which makes it difficult for people to fit a pre-molded mask. Consequently, a need still exists for an inexpensive face-mask that can be used for long periods of time and will fit the special facial features of the individual wearer.

A number of different types of safety facemask and manufacturing of facemasks are available in prior art. For example, the following patents are provided for their supportive teachings and are all incorporated by reference: U.S. Pat. No. 9,381,316 discloses a mask assembly for a user includes a frame having a main body and lateral connector portions and a cushion component provided to the frame and defining a breathing cavity configured to accommodate at least a portion of the user's nose in use. The cushion component includes a face contacting seal portion adapted to seemingly engage with at least a portion of the user's nose in use. The cushion component has an aperture to communicate pressurized gas from the breathing chamber to the user's airways in use, and a main wall portion, opposite from the aperture, extending upwardly away from the frame. The main wall portion includes a stiffening portion.

Another prior an document. EP2441494 discloses a mask with a nasal cushion, the mask consisting of a filter that filters dust, wherein, the edges of the filter are folded back to create flaps that follow the depressions on both sides of the nasal region. A sponge of urethane foam or the like is affixed inside the flaps, thereby improving the fit of the mask by conforming the mask to the contours of the nasal region, resulting in a mask cushion with a nasal cushion that has cushioning properties and strong protective capabilities.

Yet another prior an document, U.S. Pat. No. 10,494,221 discloses a method and associated system for splicing a reserve nose wire to a running nose wire in a facemask production line, wherein the running nose wire is supplied continuously from a supply roll. Prior to depletion of the running nose wire, the supply roll is moved from an operating location to an intermediate location that is further from the production line while continuing to supply the running nose wire from the supply roll. The supply roll is then moved from the intermediate location back towards the production line while decelerating the supply roll to a stop, thereby creating an accumulation of the running wire functionally between the supply roll and the production line. With the supply roil at a stop, the running nose wire is continuously supplied from the accumulation and a leading end of a reserve role of nose wire is spiked to the running nose wire at a location upstream of the accumulation where the running nose wire is at a standstill.

Yet another prior art document, U.S. Pat. No. 6,098,201 discloses a face-mask which is made of a plastic sheet in which is embedded a deformable skin-colored, plastic-coated wire mesh. The plastic sheet is moldable and has an octagonal shape that will tit over tire face of a wearer to cover the wearers nose and mouth with tabs to fit under the chin. A trapezoidal opening is formed in the plastic sheet at a location that will overlie the nose and mouth of the wearer. A fastener system, located at the perimeter of the opening, surrounds the opening to fasten detachably a filter element in a position that covers the opening. The filter element is in sheet form having a shape complementary to the shape of the opening. However, this prior art document does not appear to discuss safety facemask comprising fully adjustable nose fit.

Yet another prior art document, U.S. Pat. No. 5,107,547 discloses a medical face mask that may be quickly, easily, securely and adjustably mounted to the head of a wearer is solved in a medical face mask of the type having a panel for covering the nose and the mouth of a wearer and at least one complimentary pair of spaced apart straps and attached to the panel and extending therefrom by the straps being joined by a slidable fastener forming a loop comprising the straps and the top of the panel, the slidable fastener holding the straps in a loop or desired length until the slidable fastener is forcibly slidably adjusted to increase or decrease the size of the loop. However, this prior art document does not appear to discuss a safety facemask comprising a fully adjustable nose fit.

Yet another prior art document, U.S. Pat. No. 9,962,511 discloses a shroud tor a mask system includes a retaining portion structured to retain a frame, a pair of upper headgear connectors each including an elongated arm and a slot at the bee end of the arm adapted to receive a headgear strap, and a pair of lower headgear connectors each adapted to attach to a headgear strap. The remaining portion, the upper headgear connectors, and the lower headgear connectors are integrally formed as a one piece structure. However, this prior art document does not appear to discuss a safety facemask comprising a fully adjustable nose fit.

Yet another prior art document, US20080251210 discloses art automatic nose strip bonding apparatus for a face mask is disclosed, including a nose strip providing mechanism, a nose strip turnover mechanism, and a press-to-bond device. The nose strip providing mechanism drives a nose strip forward and carries out stamping operation on the nose strip, and applies a bonding agent to the nose strip. The nose strip turnover mechanism serves to turn over the nose strip that has already been applied with the bonding agent to allow the surface of the nose strip on which the bonding agent is applied to face a face mask. However, this prior an document does not appear to discuss a safety facemask comprising a fully adjustable nose fit.

Yet another prior art documents, CN104643314 discloses a closing frame for improving closing performance of a respirator and a face mask. The closing frame comprises a closing surface 2 which is designed according to the face characteristics of special individual; the closing frame can be matched with and fit to the face; the closing frame is printed and produced through a 3D printer. The closing frame be used when wearing the respirator or the face mask and is able to reduce air leaking from the respirator and the face mask, and therefore, the closing performance of the respirator and the face mask can be improved. However, this prior art document does not appear to discuss a safety facemask comprising a fully adjustable nose fit.

However, above mentioned references and many other similar references has one or more of the following shortcomings: (a) discussing general concept of the facemask; (b) discussing face mask comprising a string which can be adjusted for fitting the facemask; (c) disclosing only closing frame of face mask or respiratory mask; (d) discusses a facemask having cushion at the nose gap position for comfort; and (e) disclosing a facemask comprising a nose strips.

The present application addresses the above mentioned concerns and short comings with regard to providing a safety facemask comprising a fully adjustable nose fit. Further, a facemask based on a cut sheet with creased sections and bends for perfectly closing the facemask and method thereof is also disclosed.

### SUMMARY OF THE INVENTION

In the view of the foregoing disadvantages inherent in the known types of safety facemask and manufacturing of facemasks now present in the prior art, the present invention provides a facemask comprising an adjustable nose fit for perfectly closing the nose gap. As such, the general purpose of the present invention, which will be described subsequently in greater detail, is to provide a new, simple and improved adjustable facemask which has all the advantages of the prior art and none of the disadvantages.

The main objective of the present invention is to an adjustable facemask 100 to fit on a wearer comprising: a sheet 101, a plurality of curved creases 102 and 103 on the said sheet 101; an adjustor 108 or 504, and a plurality of attachment points 104, 105, 106, and 107; wherein said adjustor 108 is capable of adjusting the distances between a first attachment point KM to a second attachment point and further said adjustor 108 is also adjusting the distances between a third attachment point 106 to a fourth attachment point 107.

Another objective of the present invention is to provide the adjustable facemask 100, wherein said adjustor 108 or 504 can be a string, a ribbon or a thread.

Yet another objective of the present invention is to provide the adjustable facemask 100, wherein said plurality of attachment points 104, 105, 106, and 107 can be holes, adhesive patches, hook and loop type, snap in pins or similar arrangement.

Yet another objective of the present invention is to provide the adjustable facemask 100, wherein said adjustable facemask further comprising a pre-cut chin support 304 and 402.

Yet another objective of the present invention is to provide the adjustable facemask 100 according, wherein said pre-cut chin support 304 and 402 may comprises a simple filter media or a powered air flow module with a filter media 403.

Yet another objective of the present invention is to provide the adjustable facemask 100, wherein said powered air flow filter module 403 comprises blower fan 403A, compartment 403B, and replaceable filter media cartridge 403C.

Yet another objective of the present invention is to provide the adjustable facemask 100, wherein said sheet 500 comprises a set of primary holes 502.

Yet another objective of the present invention is to provide the adjustable facemask 100, wherein said adjustor 504 also comprises a plurality of secondary holes 503.

Yet another objective of the present invention is to provide the adjustable facemask 100, wherein said adjustable facemask further comprises an attachment component 500 having a set of pins 501, wherein said set of pins comprises hooks for gripping and matching said primary holes 502 with the said secondary holes 503.

Yet another objective of the present invention is to provide the adjustable facemask 100, wherein said adjustable facemask 100 further comprises an additional sheet 602, wherein said additional sheet 602 can be integrated in the sheet 101, or integrated in the said adjustor 108 or 504.

Yet another objective of the present invention is to provide the adjustable facemask 100, wherein said sheet comprises a transparent polymer material, a non-transparent polymer material, a paper based material or a non-woven filter based material.

Yet another objective of the present invention is to provide an adjustable facemask 600 to fit on a wearer comprising: a first sheet 601, wherein said first sheet comprises a plurality of curved creases 602 and 603, wherein said curved creases is capable of creating bends that will conform to the specific facial contour of said wearer; and a second sheet 608, wherein said second sheet comprises a plurality of attachment points 604, 605, 606 and 607, wherein said plurality of attachment points are capable of adjusting the depths of the bends and in addition acts as a protection visor towards said wearer's eyes when attached to the face.

### BRIEF DESCRIPTION OF THE DRAWINGS

The invention will be better understood and objects other than those set forth above will become apparent when consideration is achieved to the following detailed description thereof. Such description makes reference to the annexed drawings wherein:

FIG. 1A and FIG. 1B depicts a schematic representation of the adjustable facemask and the said adjustable facemask fitted on a wearer, respectively in accordance with the present invention.

FIG. 2 illustrates different string positions and the resulting contour of the adjustable facemask according to one of the embodiment of the present invention.

FIG. 3 depicts the adjustable facemask fitted on the face according to one of the embodiment of the present invention.

FIG. 4A and FIG. 4B depicts the adjustable facemask with forced air flow and separable filter media according to one of the embodiment of the present invention.

FIG. 5A and FIG. 5B depicts a representation of the facemask with snap in holes and an attachment component with mating pins.

FIG. 6A and FIG. 6B depicts the facemask with an added eye visor function and the said facemask fitted on a wearer, respectively in accordance with the present invention.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense.

Selection of respiratory protection for pollution hazards is typically based upon the airborne concentration of the substance that the wearer is exposed to, fit of the respirator and the hazard exposure limit of that substance. There are several types of masks today used, for example (i) Surgical Mask (or safety mask): (ii) Respiratory mask (respirators); (iii) Simple fabric masks; (iv) Homemade face coverings. The surgical mask (or safety mask) is used for preventing the large particles expelled by the wearer such as spit or mucous, from entering the environment. If wearer coughs or sneezes, the surgical mask will help collect the larger particles expelled. The respiratory masks comprising of the filter cartridge. It filters particles from the air when properly fitted, helping reduce the number of particles or germs the wearer breathes in. Generally, it is ideal for achieving sufficient filtering of PM 2.5. The respiratory masks are secured tightly to the face, with 2 head straps and a nose adjustable clip over the nose to allow for a more custom fit. The simple fabric masks, such as cotton sewed masks, and homemade masks, such as a neck tube or wrapped fabric, are mostly effective for protecting from temperature differences and in some cases contaminated droplets. However, for all of these it is possible that the mask will not perfectly fit to the wearer, resulting in low level of efficiency and low level of comfort for the wearer.

Currently, the whole world is passing through the critical situation of coronavirus pandemic. In the context of a pandemic, stopping the infection in both directions can be equally important in preventing a communicable disease from spreading. In the time of pandemic situation, there is a need for all types of protective respiratory mask ranging from high end filter cartridge face masks to homemade fabric masks. For all of these types of face protections the fit and sealing function will contribute highly to both the protection level and comfort of the mask. Further there is need to manufacture respiratory masks or parts for respiratory masks in bulk production. Moreover, the medical professionals and security professionals are in need of regular supply of respiratory masks.

Currently, available majority of the facemasks are having solid or metallic strips at the nose area. These solid or metallic strips not giving comfortable feeling to the wearer. The need of the hour is to provide the wearer (the person) with very comfortable face mask, for which they love to wear the face mask as and when required. The present invention provides a facemask comprising an arrangement to perfectly fit the facemask to the wearer. The present invention provides a facemask. perfectly fit to the persons, irrespective of their age, face shape or size of the face. The present invention provides a facemask comprising a thread (or string or band or wire), the string (or thread or ribbon) is capable of adjusting the contact contour at the nose area and making the facemask perfectly fit to the wearer. The production of face masks with an adjustable nose fit can be made by simply cutting a sheet of material into shape at high production volume, while still enabling the wearer to achieve a good sealing level and comfortable fit by the present invention.

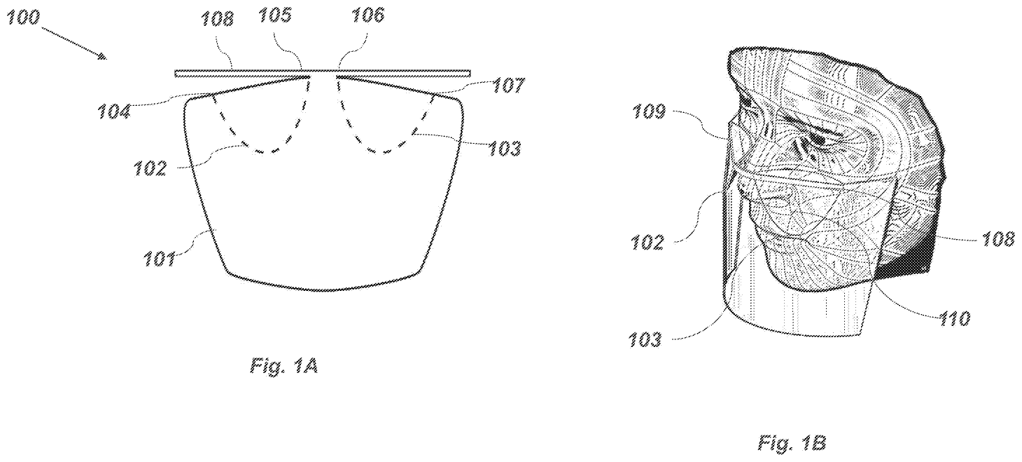

FIG. 1A and FIG. 1B depicts a schematic representation of the adjustable facemask and the said facemask fitted on a wearer, respectively in accordance with the present invention. The adjustable facemask of the present invention according to one the embodiment is represented as 100 in FIG. 1A. The adjustable facemask 100 comprising a sheet 101, a plurality of curved creases 102 and 103 on the sheet 101 at the nose area (upper side). The adjustable facemask 100 also comprises an adjustor 108 (a string (or ribbon or thread)). The adjustable facemask comprising a plurality of attachment points 104, 105, 106, and 107. By adjusting the restricted distance between 104 to 105 and 106 to 107 the depths of the bends 109 and 110 can be adjusted so that the bends will conform to the specific facial contour of the user. The means of restricting the distance depicted as the adjustor 108, which can be a string or a ribbon. The type of sheet 101 can be of a transparent or non-transparent, polymer material, or a paper based material or a non-woven filter based material. The means of attachment points 104, 105, 106, and 107 can be holes, adhesive patches, hook and loop type, snap in pins or similar. The lower part of the face cover can be equipped with mean to seal and support toward the chin such as an integrated filter media. The sheet 101 can be transparent to minimize the obstruction of the facial expressions.

In one embodiment the main facemask is manufactured as a whole from cutting a sheet of polymer or fiber based material into a similar shape as depicted in FIG. 1A where the ribbon 108 is an integrated part of the one piece cut sheet, and in production making the creases at 102 and 103 by a relief type automatic operation. The adjustor (ribbon) 108 will then by the wearer be attached at points 104 and 107 respectively by means of a snap in or tape adhesive to create the correct depth of the bends 109 and 110 to seal towards the wearers facial nose contour. The plurality of attachment points 104, 105, 106, and 107 can be holes, adhesive patches, hook and loop type, snap in pins or similar arrangement.

FIG. 1B depicts when the wearer or user wears the facemask 100. In an alternate embodiments of the present invention, the facemask comprising a strip instead of string (or ribbon), wherein the strip comprises a plurality of tabs. The facemask may comprise a plurality of holes having a shape (and/or size) in which a plurality of tabs can be fit in by snap-it.

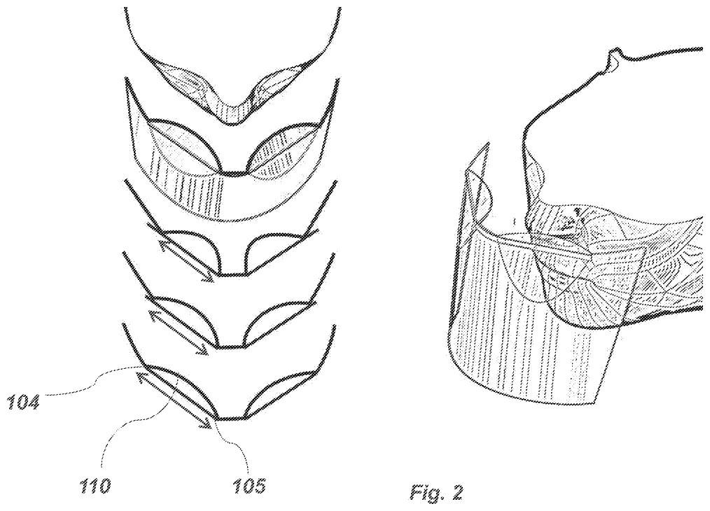

FIG. 2 illustrates a different strings or positions of the facemask according to one of the embodiment of the present invention. FIG. 2 depicts an example of different bends and the resulting contours. FIG. 2 clearly indicates when the string or ribbon is fasten or loosen how the distance between the attachment points 104 to 105 is changing and this resulting in different shaped contours that can align to different wearer face contours. Similarly, for the second half of the facemask the distance between the holes (points) 106 to 107.

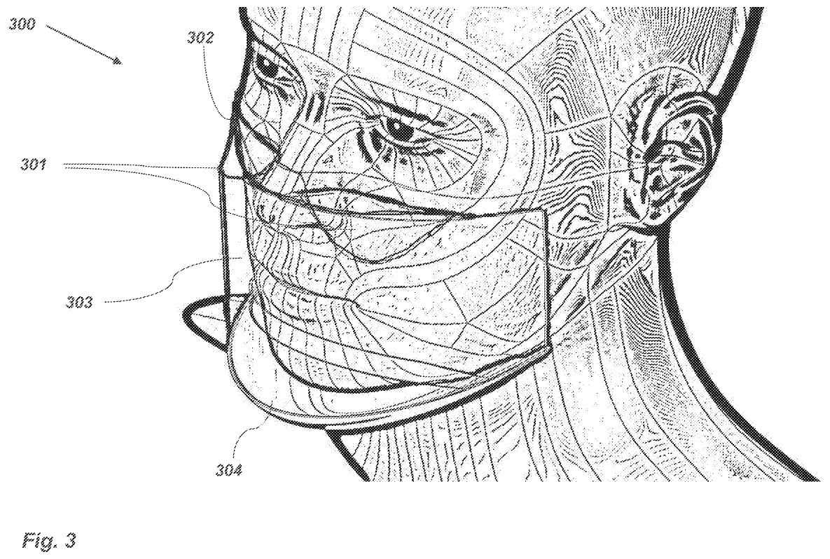

FIG. 3 represents how the facemask is fitted on the face of the user. FIG. 3 depicts the facemask according to one of the embodiment of the present invention The facemask 300 comprises a plurality of curved creases 301, a band 302 to define the curvature of the bends, a transparent region 303, and a pre-cut chin support 304 with integrated filter media. The tailor made safety facemask may also comprise a filter cartridge (filter media). The filter cartridge (or filter media) can be fitted or snapped on the lower part of the transparent pre-cut part The transparent pre-cut sheet may have attachment means for the chin supporting filter media such as snap in holes or glue type adhesive attachments. In an alternate embodiment the transparent sheet 303 is treated in part or as a whole on the side facing the mouth with a moisture absorbing coating or surface altering processing to prevent loss of visual appearance due to fogging. The coating can be a moisture absorbing polymer material such as poly(vinyl pyrrolidone) or poly(vinyl alcohol), or a coating composition containing moisture-absorbing particulates, such as cornstarch, xanthan gum, inorganic oxides or other moisture absorbing means. The surface altering processing can be a micro embossing pattern processing to allow for moisture to collect in micro cavities.

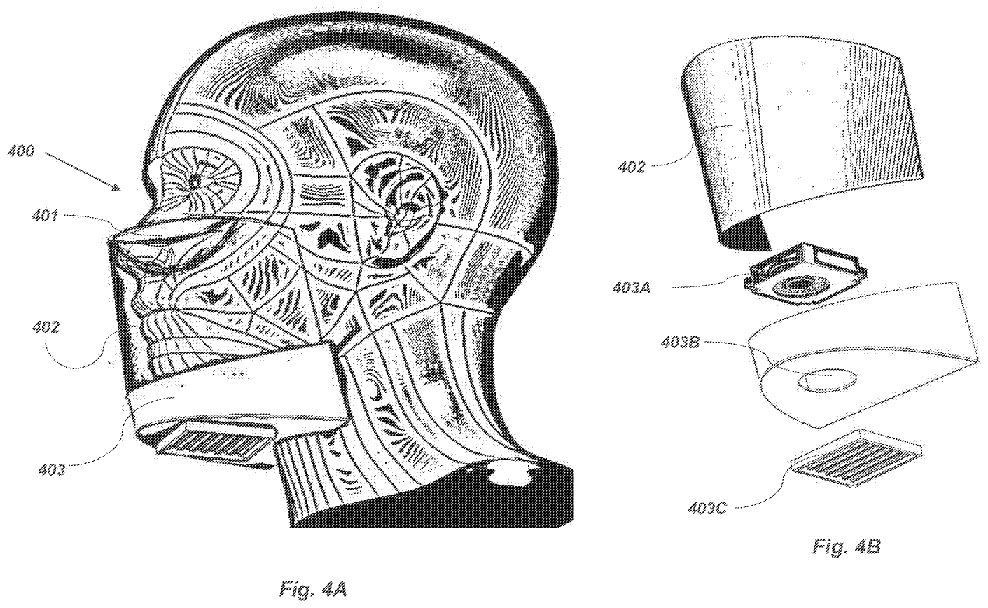

FIG. 4A and FIG. 4B depicts the facemask with forced air flow and a separable filter media according to one of the embodiment of the present invention. FIG. 4A represents how the tailor made safety facemask having biter media is worn by the user on the face. The facemask 400 comprises several parts, curved creases 401, a transparent pre-cut sheet 402, and a powered air flow module with a filter media 403.

FIG. 4B depicts the exploded view of the powered air flow filter media. The powered air flow filter module 403 comprises blower fan 403A, compartment 403B, and replaceable filter media cartridge 403C. Further, the compartment 403B is designed to hold the blower fan 403A and replaceable filter media cartridge 403C. In this embodiment, the filter media cartridge includes a powered forced air flow to allow for a slight positive pressure in the mask inside cavity to increase comfort and easy of breathing. It can also reduce the moisture build up by providing a slight excess of outside air. All air entering the mask cavity will be filtered by a replaceable filter media part. The powered forced air can be controlled by a computer that monitors breathing and adjusts flow to relax the users breathing.

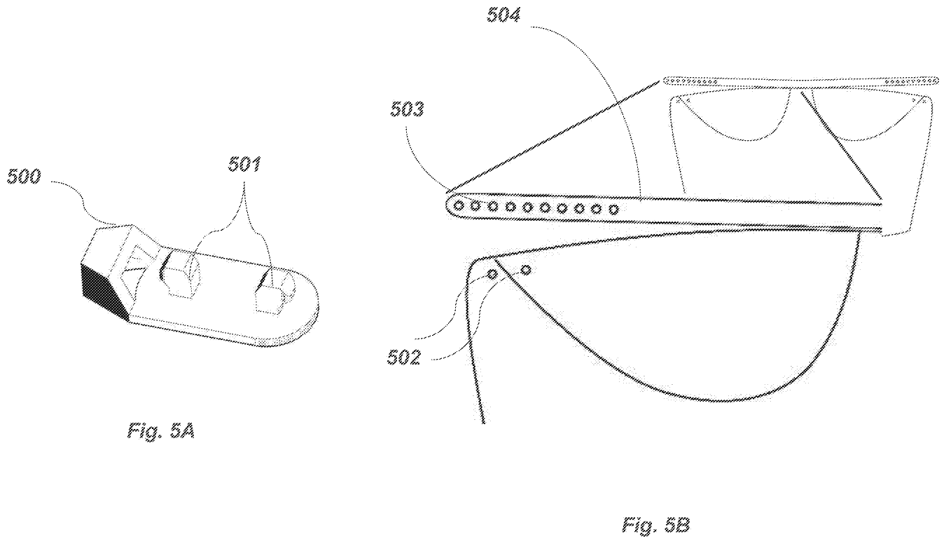

FIG. 5A depicts an attachment component 500 with a set of pin(s) 501. The facemask sheet comprises a set of primary holes 502 and the adjustor/ribbon comprises a plurality of secondary holes 503. The set of pins 501 of the attachment component 500 is used have hooks to grip the facemask sheet at the hole(s) 502, and where the same pins 501 also can grip the hole(s) 503 on the ribbon/adjustor 504 to allow simple adjustment of the bend to fit a specific wearer as described in this invention. FIG. 5B depicts the detail of the attachment method on one side of the facemask including hole(s) 502 on the facemask sheet, and hole(s) 503 on the ribbon/adjustor 504.

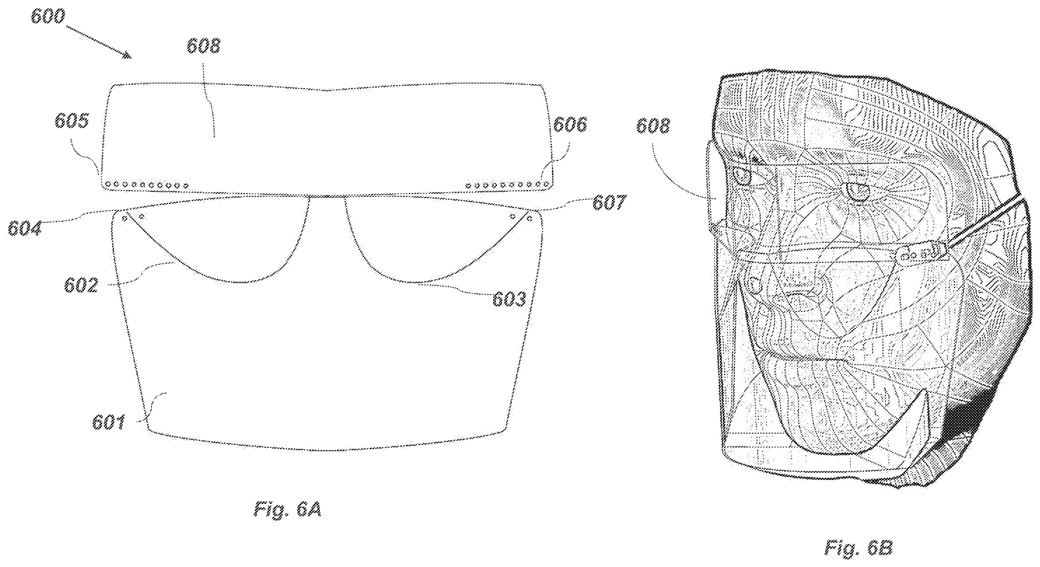

FIG. 6A and FIG. 6B depicts a schematic representation of the facemask and the said facemask fitted on a wearer, respectively in accordance with the present invention. The facemask of the present invention according to one the embodiment is represented as 600 in FIG. 6A. The facemask 600 comprising a first sheet 601, a plurality of curved creases 602 and 603 on the sheet 601 at the nose area (upper side). The facemask 600 also comprising a second sheet 608 that will act as a protection visor towards the wearers eyes when attached to the face. The second sheet 608 can be a transparent sheet. The facemask comprising a plurality of attachment points 604 and 607 on the facemask sheet 601. The facemask also comprising a plurality of attachment points 605 and 606 on the second sheet 608. By adjusting the restricted distance by fastening the second sheet 608 with the attachment point 604, 605, 606 and 607 the depths of the bends can be adjusted so that the bends will conform to the specific facial contour of the user. The plurality of attachment points 604, 605, 606 and 607 are capable of adjusting the depths of the bends and in addition acts as a protection visor towards said wearer's eyes when attached to the face.

The type of sheet 601 can be of a transparent or non-transparent polymer material, or a paper based material or a non-woven filter based material. The means of attachment points 604, 605, 606, and 607 can be holes, adhesive patches, hook and loop type, snap in pins or similar. The lower part of the face cover can be equipped with mean to seal and support toward the chin such as an integrated filter media. The sheets 601 and 608 can be transparent to minimize the obstruction of the facial expressions. The first sheet 601 and the second sheet 608 can be integrated in one piece or separate cut sheets.

In one embodiment the main facemask is manufactured as a whole from cutting a sheet, of polymer or fiber based material into a similar shape as depicted in FIG. 6A where the sheet 608 is an integrated part of the one piece cut sheet, and in production making the creases at 602 and 603 by a relief type automatic operation. FIG. 6B depicts when the wearer or user wears the facemask 600. The second sheet 608 will act as an eye protection visor in this alternate embodiment of the present invention.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed is:

1. An adjustable facemask to fit on a wearer comprising:
a sheet,
a plurality of curved creases on the said sheet, wherein said curved creases is capable of creating bends that will conform to the specific facial contour of said wearer,
an adjustor, and
a plurality of attachment points, wherein said attachment points are capable of adjusting the depths of bends;
wherein said adjustor is capable of adjusting the distances between a first attachment point to a second attachment point and further said adjustor is also adjusting the distances between a third attachment point to a fourth attachment point.

2. The adjustable facemask according to claim 1, wherein said adjustor can be a string, a ribbon or a thread.

3. The adjustable facemask according to claim 1, wherein said plurality of attachment points comprises holes, adhesive patches, hook and loop type, snap in pins or similar arrangement.

4. The adjustable facemask according to claim 1, wherein said adjustable facemask further comprising a pre-cut chin support.

5. The adjustable facemask according to claim 1, wherein said sheet comprises a set of primary holes.

6. The adjustable facemask according to claim 2, wherein said adjustor also comprises a plurality of secondary holes.

7. The adjustable facemask according to claim 1, wherein said adjustable facemask further comprises an attachment component having a set of pins, wherein said set of pins comprises hooks for gripping and matching said primary holes with the said secondary holes.

8. The adjustable facemask according to claim 1, wherein said adjustable facemask further comprises an additional sheet, wherein said additional sheet can be integrated in the sheet or integrated in the said adjustor.

9. The adjustable facemask according to claim 1, wherein said sheet comprises a transparent polymer material, a non-transparent polymer material a paper based material or a non-woven filter based material.

10. An adjustable facemask to fit on a wearer comprising:
a first sheet, wherein said first sheet comprises a plurality of curved creases, wherein said curved creases is capable of creating bends that will conform to the specific facial contour of said wearer; and
a second sheet, wherein said second sheet comprises a plurality of attachment points,
wherein said plurality of attachment points are capable of adjusting the depths of the bends and in addition acts as a protection visor towards said wearer's eyes when attached to the face.
